(19) United States
(12) Patent Application Publication
(10) Pub. No.: US 2012/0139906 A1
(43) Pub. Date: Jun. 7, 2012

(54) HYBRID REALITY FOR 3D HUMAN-MACHINE INTERFACE

(75) Inventors: Xuerui Zhang, San Diego, CA (US); Ning Bi, San Diego, CA (US); Yingyong Qi, San Diego, CA (US)

(73) Assignee: QUALCOMM Incorporated, San Diego, CA (US)

(21) Appl. No.: 13/234,028

(22) Filed: Sep. 15, 2011

Related U.S. Application Data
(60) Provisional application No. 61/419,550, filed on Dec. 3, 2010.

(51) Int. Cl. G06T 15/00

(52) U.S. Cl. 345/419

(57) ABSTRACT

A three dimensional (3D) mixed reality system combines a real 3D image or video, captured by a 3D camera for example, with a virtual 3D image rendered by a computer or other machine to render a 3D mixed-reality image or video. A 3D camera can acquire two separate images (a left and a right) of a common scene, and superimpose the two separate images to create a real image with a 3D depth effect. The 3D mixed-reality system can determine a distance to a zero disparity plane for the real 3D image, determine one or more parameters for a projection matrix based on the distance to the zero disparity plane, render a virtual 3D object based on the projection matrix, combine the real image and the virtual 3D object to generate a mixed-reality 3D image.

This application claims the benefit of U.S. Provisional Application 61/419,550, filed Dec. 3, 2010, the entire contents of which are incorporated herein by reference in its entirety.

### TECHNICAL FIELD

This disclosure relates generally to processing and rendering of multimedia data, and more particularly to processing and rendering of three-dimensional (3D) picture and video data that has both virtual objects and real objects.

### BACKGROUND

Computational complexity of stereo video processing is an important consideration in rendering of three-dimensional (3D) graphics and, specifically, in visualization of 3D scenes in low power devices or in real-time settings. In general, difficulties in rendering of 3D graphics on a stereo-enabled display (e.g., auto-stereoscopic or stereoscopic display) may result due to the computational complexity of the stereo video processing.

Computational complexity can be a particularly important consideration for real-time hybrid-reality video devices that generate mixed reality scenes with both real objects and virtual objects. Visualization of mixed reality 3D scenes may be useful in many applications such as video games, user interfaces, and other 3D graphics applications. Limited computational resources of low-power devices may cause rendering of 3D graphics to be an excessively time-consuming routine, and time consuming routines are generally incompatible with real-time applications.

### SUMMARY

Three dimensional (3D) mixed reality combines a real 3D image or video, captured by a 3D camera for example, with a virtual 3D image rendered by a computer or other machine. A 3D camera can acquire two separate images (a left and a right, for example) of a common scene, and superimpose the two separate images to create a real image with a 3D depth effect. Virtual 3D images are not typically generated from images acquired by a camera, but instead, are drawn by a computer graphics program such as OpenGL. With a mixed-reality system that combines both real and virtual 3D images, a user can feel immersed in a space that is composed of both virtual objects drawn by a computer and real objects captured by a 3D camera. The present disclosure describes techniques that may for the generation of mixed scenes in a computationally efficient manner.

In one example, a method includes determining a distance to a zero disparity plane for a real three-dimensional (3D) image; determining one or more parameters for a projection matrix based at least in part on the distance to the zero disparity plane; rendering a virtual 3D object based at least in part on the projection matrix; and, combining the real image and the virtual object to generate a mixed reality 3D image.

In another example, a system for processing three-dimensional (3D) video data includes a real 3D image source, wherein the real image source is configured to determine a distance to a zero disparity plane for a captured 3D image; a virtual image source configured to determine one or more parameters for a projection matrix based at least on the distance to the zero disparity plane and render a virtual 3D object based at least in part on the projection matrix; and, a mixed scene synthesizing unit configured to combining the real image and the virtual object to generate a mixed reality 3D image.

In another example, an apparatus includes means for determining a distance to a zero disparity plane for a real three-dimensional (3D) image; means for determining one or more parameters for a projection matrix based at least in part on the distance to the zero disparity plane; means for rendering a virtual 3D object based at least in part on the projection matrix; and, means for combining the real image and the virtual object to generate a mixed reality 3D image.

The techniques described in this disclosure may be implemented in hardware, software, firmware, or any combination thereof. If implemented in hardware, an apparatus may be realized as an integrated circuit, a processor, discrete logic, or any combination thereof. If implemented in software, the software may be executed in one or more processors, such as a microprocessor, application specific integrated circuit (ASIC), field programmable gate array (FPGA), or digital signal processor (DSP). The software that executes the techniques may be initially stored in a computer-readable medium and loaded and executed in the processor.

According, in another example, a non-transitory, computer readable storage medium tangibly store one or more instructions, which when executed by one or more processors cause the one or more processors to determine a distance to a zero disparity plane for a real three-dimensional (3D) image; determine one or more parameters for a projection matrix based at least in part on the distance to the zero disparity plane; render a virtual 3D object based at least in part on the projection matrix; and, combine the real image and the virtual object to generate a mixed reality 3D image.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a block diagram illustrating an example system configured to perform the techniques of this disclosure.

FIG. 2 is a block diagram illustrating an example system in which a source device sends three-dimensional (3D) image data to a destination device in accordance with the techniques of this disclosure.

FIGS. 3A-3C are conceptual diagrams illustrating examples of positive, zero, and negative disparity values, respectively, based on depths of pixels.

FIG. 4A is a conceptual top-down view of a two camera system for acquiring a stereoscopic view of a real scene and the field of view encompassed by the resulting 3D image.

FIG. 4B is a conceptual side view of the same two camera system as shown in FIG. 4A.

FIG. 5A is a conceptual top-down view of a virtual display scene.

FIG. 5B is a conceptual side view of the same virtual display scene as shown in FIG. 5A.

FIG. 6 is a 3D illustration showing a 3D viewing frustum for rendering a mixed-reality scene.

FIG. 7 is a conceptual top-down view of the viewing frustum of FIG. 6.

FIG. 8 is a flow diagram illustrating techniques of the present disclosure.

### DETAILED DESCRIPTION

Three dimensional (3D) mixed reality combines a real 3D image or video, captured by a 3D camera for example, with a virtual 3D image rendered by a computer or other machine. A 3D camera can acquire two separate images (a left and a right, for example) of a common scene, and superimpose the two separate images to create a real image with a 3D depth effect. Virtual 3D images are not typically generated from images acquired by a camera, but instead, are drawn by a computer graphics program such as OpenGL. With a mixed-reality system that combines both real and virtual 3D images, a user can feel immersed in a space that is composed of both virtual objects drawn by a computer and real objects captured by a 3D camera. In an example of a 1-way mixed-reality scene, a viewer may be able to view a salesman (real object) in a showroom where the salesman interacts with virtual objects, such as a computer-generated virtual 3D car (virtual object). In an example of a 2-way mixed reality scene, a first user at a first computer may interact with a second user at a second computer in a virtual game, such as a virtual game of chess. The two computers may be located at distant physical locations relative to one another, and may be connected over a network, such as the internet. On a 3D display, the first user may be able to see 3D video of the second user (a real object) with a computer-generated chess board and chess pieces (virtual objects). On a different 3D display, the second user might be able to see 3D video of the first user (a real object) with the same computer generated chess board (a virtual object).

In a mixed reality system, as described above, the stereo display disparity of the virtual scene, which consists of virtual objects, needs to match the stereo display disparity of the real scene, which consists of real objects. The term “disparity” generally describes the horizontal offset of a pixel in one image (e.g. a left real image) relative to a corresponding pixel in the other image (e.g. a right real image) to produce a 3D effect, such as depth. Disparity mismatch between a real scene and virtual scene may cause undesirable effects when the real scene and the virtual scene are combined into a mixed reality scene. For example, in the virtual chess game, disparity mismatch may cause the chess board (a virtual object) in the mixed scene to appear partially behind a user (a real object) or may appear to protrude into the user, instead of appearing to be in front of the user. As another example in the virtual chess game, disparity mismatch may cause a chess piece (a virtual object) to have an incorrect aspect ratio and to appear distorted in the mixed reality scene with a person (a real object).

In addition to the matching disparity of the virtual scene and the real scene, it is also desirable to match the projective scale of the real scene and virtual scene. Projective scale, as will be discussed in more detail below, generally refers to the size and aspect ratio of an image when projected onto a display plane. Projective scale mismatch between a real scene and a virtual scene may cause virtual objects to be either too big or too small relative to real objects or may cause virtual objects to have a distorted shape relative to real objects.

Techniques of this disclosure include an approach for achieving projective scale match between a real image of a real scene and a virtual image of a virtual scene and an approach for achieving disparity scale match between a real image of a real scene and a virtual image of a virtual scene. The techniques can be applied in a computationally efficient manner in either the upstream or downstream direction of a communication network, i.e., by either a sender of 3D image content or a receiver of 3D image content. Unlike existing solutions, the techniques of this disclosure may also be applied in the display chain to achieve correct depth sensation between real scenes and virtual scenes in real-time applications.

The term “disparity” as used in this disclosure generally describes the horizontal offset of a pixel in one image relative to a corresponding pixel in the other image so as to produce a 3D effect. Corresponding pixels, as used in this disclosure, generally refer to pixels (one in a left image and one in a right image) that are associated with the same point in the 3D object when the left image and right image are synthesized to render the 3D image.

A plurality of disparity values for a stereo pair of images can be stored in a data structure that is referred to as a disparity map. The disparity map associated with the stereo pair of images represents a two-dimensional (2D) function, d(x, y), that maps pixel coordinates (x, y) in the first image to disparity values (d), such that the value of d at any given (x, y) coordinate in a first image corresponds to the shift in the x-coordinate that needs to be applied to a pixel at coordinate (x, y) in the second image to find the corresponding pixel in the second image. For example, as a specific illustration, a disparity map may store a d value of 6 for a pixel at coordinates (250, 150) in the first image. In this illustration, given the d value of 6, data describing pixel (250, 150), such as chroma and luminance values, in the first image, occurs at pixel (256, 150) in the second image.

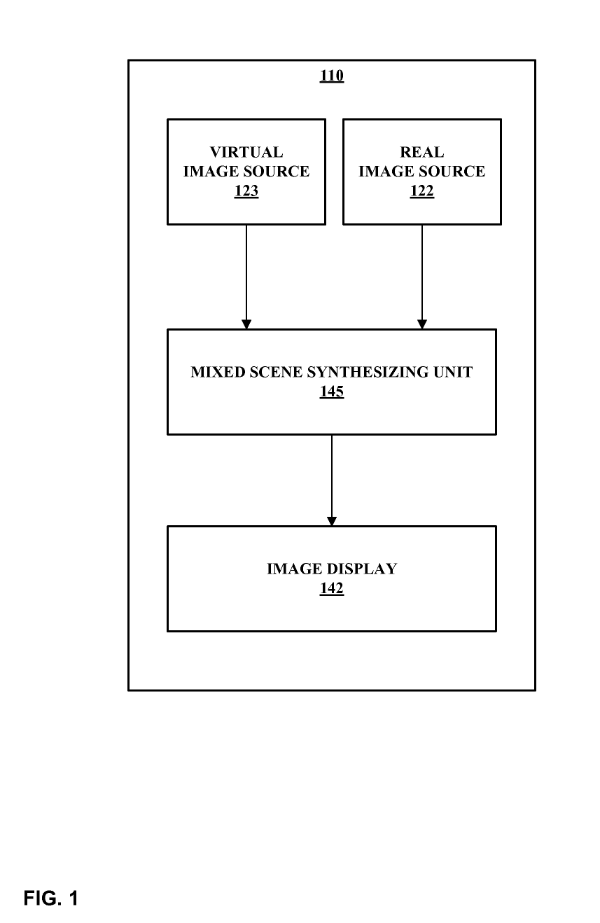

FIG. 1 is a block diagram illustrating an example system, system 110, for implementing aspects of the present disclosure. As shown in FIG. 1, system 110 includes a real image source 122, a virtual image source 123, a mixed scene synthesizing unit (MSSU) 145, and image display 142. MSSU 145 receives a real image from real image source 122 and receives a virtual image from virtual image source 123. The real image may, for example, be a 3D image captured by a 3D camera, and the virtual image may, for example, be a computer-generated 3D image. MSSU 145 generates a mixed reality scene that includes both real objects and virtual objects, and outputs the mixed reality scene to image display 142. In accordance with techniques of this disclosure, MSSU 145 determines a plurality of parameters for the real image, and based on those parameters, generates the virtual image such that the projective scale and disparity of the virtual image match the projective scale and disparity of the real image.

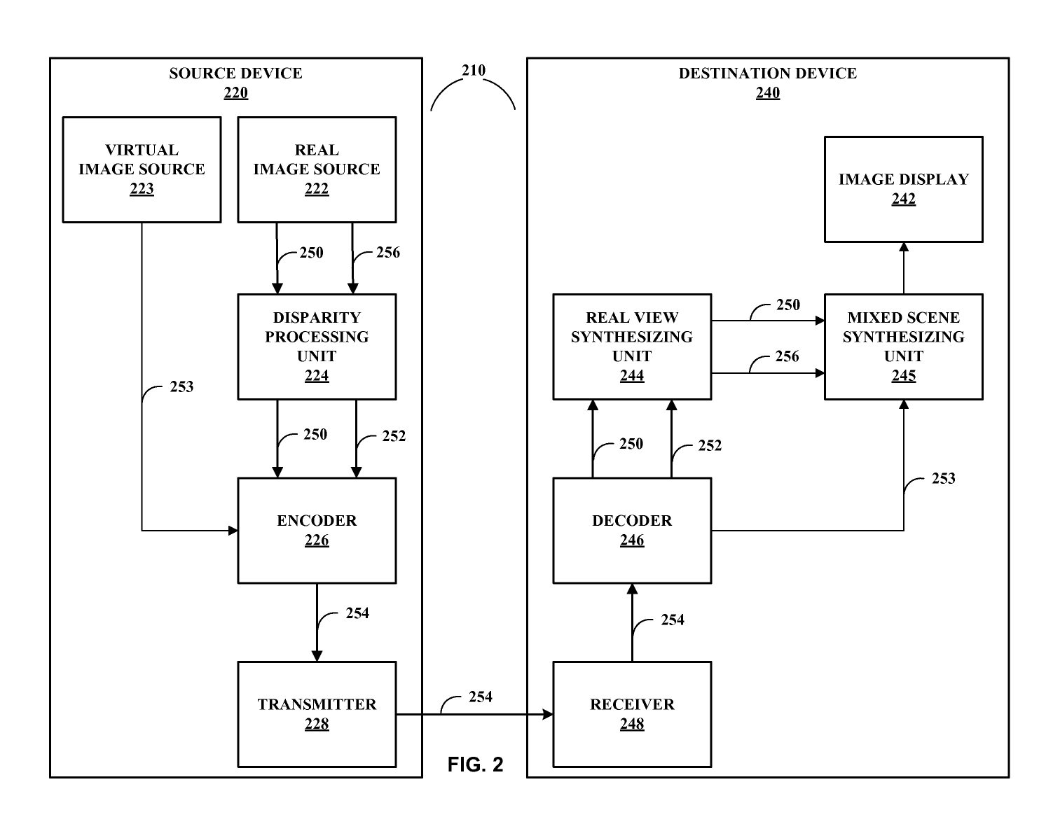

FIG. 2 is a block diagram illustrating another example system, system 210, for implementing aspects of the present disclosure. As shown in FIG. 2, system 210 may include a source device 220 with a real image source 222, a virtual image source 223, a disparity processing unit 224, an encoder 226, and a transmitter 228, and may further include a destination device 240 with an image display 242, a real view synthesizing unit 244, a mixed scene synthesizing unit (MSSU) 245, a decoder 246, and a receiver 248. The systems of FIG. 1 and FIG. 2 are merely two examples of the types of systems in which aspects of this disclosure can be implemented and will be used for purposes of explanation. As will be discussed in more detail below, in alternate systems implementing aspects of this disclosure, the various elements of system 210 may be arranged differently, replaced by alternate elements, or in some cases omitted altogether.

In the example of FIG. 2, destination device 240 receives encoded image data 254 from source device 220. Source device 220 and/or destination device 240 may comprise personal computers (PCs), desktop computers, laptop computers, tablet computers, special purpose computers, wireless communication devices such as smartphones, or any devices that can communicate picture and/or video information over a communication channel. In some instances, a single device may be both a source device and a destination device that supports two-way communication, and thus, may include the functionality of both source device 220 and destination device 240. The communication channel between source device 220 and destination device 240 may comprise a wired or wireless communication channel and may be a network connection such as the internet or may be a direct communication link. Destination device 240 may be referred to as a three-dimensional (3D) display device or a 3D rendering device.

Real image source 222 provides a stereo pair of images, including first view 250 and second view 256, to disparity processing unit 224. Disparity processing unit 224 uses first view 250 and second view 256 to generate 3D processing information 252. Disparity processing unit 224 transfers the 3D processing information 252 and one of the two views (first view 250 in the example of FIG. 2) to encoder 226, which encodes first view 250 and the 3D processing information 252 to form encoded image data 254. Encoder 226 also includes virtual image data 253 from virtual image source 223 in encoded image data 254. Transmitter 228 transmits encoded image data 254 to destination device 240.

Receiver 248 receives encoded image data 254 from transmitter 228. Decoder 246 decodes encoded image data 254 to extract first view 250 and to extract 3D processing information 252 as well as virtual image data 253 from encoded image data 254. Based on the first view 250 and the 3D processing information 252, view synthesizing unit 244 can reconstruct the second view 256. Based on the first view 250 and the second view 256, real view synthesizing unit 244 can render a real 3D image. Although not shown in FIG. 1, first view 250 and second view 256 may undergo additional processing at either source device 220 or destination device 240. Therefore, in some examples, the first view 250 that is received by view synthesizing unit 244 or the first view 250 and second view 256 that are received by image display 242 may actually be modified versions of the first view 250 and second view 256 received from image source 256.

The 3D processing information 252 may, for example, include a disparity map or may contain depth information based on a disparity map. Various techniques exist for determining depth information based on disparity information, and vice versa. Thus, whenever the present disclosure discusses encoding, decoding, or transmitting disparity information, it is also contemplated that depth information based on the disparity information can be encoded, decoded, or transmitted.

Real image source 222 may include an image sensor array, e.g., a digital still picture camera or digital video camera, a computer-readable storage medium comprising one or more stored images, or an interface for receiving digital images from an external source. In some examples, real image source 222 may correspond to a 3D camera of a personal computing device such as a desktop, laptop, or tablet computer. Virtual image source 223 may include a processing unit that generates digital images such as by executing a video game or other interactive multimedia source, or other sources of image data. Real image source 222 may generally correspond to a source of any one type of captured or pre-captured images. In general, references to images in this disclosure include both still pictures as well as frames of video data. Thus, aspects of this disclosure may apply both to still digital pictures as well as frames of captured digital video data or computer-generated digital video data.

Real image source 222 provides image data for a stereo pair of images 250 and 256 to disparity processing unit 224 for calculation of disparity values between the images. The stereo pair of images 250 and 256 comprises a first view 250 and a second view 256. Disparity processing unit 224 may be configured to automatically calculate disparity values for the stereo pair of images 250 and 256, which in turn can be used to calculate depth values for objects in a 3D image. For example, real image source 222 may capture two views of a scene at different perspectives, and then calculate depth information for objects in the scene based on a determined disparity map. In various examples, real image source 222 may comprise a standard two-dimensional camera, a two camera system that provides a stereoscopic view of a scene, a camera array that captures multiple views of the scene, or a camera that captures one view plus depth information.

Real image source 222 may provide multiple views (i.e. first view 250 and second view 256), and disparity processing unit 224 may calculate disparity values based on these multiple views. Source device 220, however, may transmit only a first view 250 plus 3D processing information 252 (i.e. the disparity map or depth information for each pair of views of a scene determined from the disparity map). For example, real image source 222 may comprise an eight camera array, intended to produce four pairs of views of a scene to be viewed from different angles. Source device 220 may calculate disparity information or depth information for each pair of views and transmit only one image of each pair plus the disparity information or depth information for the pair to destination device 240. Thus, rather than transmitting eight views, source device 220 may transmit four views plus depth/disparity information (i.e. 3D processing information 252) for each of the four views in the form of a bitstream including encoded image data 254, in this example. In some examples, disparity processing unit 224 may receive disparity information for an image from a user or from another external device.

Disparity processing unit 224 passes first view 250 and 3D processing information 252 to encoder 226. 3D processing information 252 may comprise a disparity map for a stereo pair of images 250 and 256. Encoder 226 forms encoded image data 254, which includes encoded image data for first view 250, 3D processing information 252, and virtual image data 253. In some examples, encoder 226 may apply various lossless or lossy coding techniques to reduce the number of bits needed to transmit encoded image data 254 from source device 220 to destination device 240. Encoder 226 passes encoded image data 254 to transmitter 228.

When first view 250 is a digital still picture, encoder 226 may be configured to encode the first view 250 as, for example, a Joint Photographic Experts Group (JPEG) image. When first view 250 is a frame of video data, encoder 226 may be configured to encode first view 250 according to a video coding standard such as, for example Motion Picture Experts Group (MPEG), MPEG-2, International Telecommunication Union (ITU) H.263, ITU-T H.264/MPEG-4, H.264 Advanced Video Coding (AVC), the emerging HEVC standard sometimes referred to as ITU-T H.265, or other video encoding standards. The ITU-T H.264/MPEG-4 (AVC) standard, for example, was formulated by the ITU-T Video Coding Experts Group (VCEG) together with the ISO/IEC Moving Picture Experts Group (MPEG) as the product of a collective partnership known as the Joint Video Team (JVT). In some aspects, the techniques described in this disclosure may be applied to devices that generally conform to the H.264 standard. The H.264 standard is described in ITU-T Recommendation H.264, Advanced Video Coding for generic audiovisual services, by the ITU-T Study Group, and dated March, 2005, which may be referred to herein as the H.264 standard or H.264 specification, or the H.264/AVC standard or specification. The Joint Video Team (JVT) continues to work on extensions to H.264/MPEG-4 AVC. New video coding standards, such as the emerging HEVC standard continue to evolve and emerge. The techniques described in this disclosure may be compatible with both current generation standards such as H.264 as well as future generation standards such as the emerging HEVC standard.

Disparity processing unit 224 may generate 3D processing information 252 in the form of a disparity map. Encoder 226 may be configured to encode the disparity map as part of 3D content transmitted in a bitstream as encoded image data 254. This process can produce one disparity map for the one captured view or disparity maps for several transmitted views. Encoder 226 may receive one or more views and the disparity maps, and code them with video coding standards like H.264 or HEVC, which can jointly code multiple views, or scalable video coding (SVC), which can jointly code depth and texture.

As noted above, image source 222 may provide two views of the same scene to disparity processing unit 224 for the purpose of generating 3D processing information 252. In such examples, encoder 226 may encode only one of the views along with the 3D processing information 256. In general, source device 220 can be configured to send a first image 250 along with 3D processing information 252 to a destination device, such as destination device 240. Sending only one image along with a disparity map or depth map may reduce bandwidth consumption and/or reduce storage space usage that may otherwise result from sending two encoded views of a scene for producing a 3D image.

Transmitter 228 may send a bitstream including encoded image data 254 to receiver 248 of destination device 240. For example, transmitter 228 may encapsulate encoded image data 254 in a bitstream using transport level encapsulation techniques, e.g., MPEG-2 Systems techniques. Transmitter 228 may comprise, for example, a network interface, a wireless network interface, a radio frequency transmitter, a transmitter/receiver (transceiver), or other transmission unit. In other examples, source device 220 may be configured to store the bitstream including encoded image data 254 to a physical medium such as, for example, an optical storage medium such as a compact disc, a digital video disc, a Blu-Ray disc, flash memory, magnetic media, or other storage media. In such examples, the storage media may be physically transported to the location of destination device 240 and read by an appropriate interface unit for retrieving the data. In some examples, the bitstream including encoded image data 254 may be modulated by a modulator/demodulator (MODEM) before being transmitted by transmitter 228.

After receiving the bitstream with encoded image data 254 and decapsulating the data, in some examples, receiver 248 may provide encoded image data 254 to decoder 246 (or to a MODEM that demodulates the bitstream, in some examples). Decoder 246 decodes first view 250, 3D processing information 252, and virtual image data 253 from encoded image data 254. For example, decoder 246 may recreate first view 250 and a disparity map for first view 250 from the 3D processing information 252. After decoding of the disparity maps, a view synthesis algorithm can be implemented to generate the texture for other views that have not been transmitted. Decoder 246 may also send first view 250 and 3D processing information 252 to real view synthesizing unit 244. Real view synthesizing unit 244 recreates the second view 256 based on the first view 250 and 3D processing information 252.

In general, the human vision system (HVS) perceives depth based on an angle of convergence to an object. Objects relatively nearer to the viewer are perceived as closer to the viewer due to the viewer's eyes converging on the object at a greater angle than objects that are relatively further from the viewer. To simulate three dimensions in multimedia such as pictures and video, two images are displayed to a viewer, one image (left and right) for each of the viewer's eyes. Objects that are located at the same spatial location within the image will be generally perceived as being at the same depth as the screen on which the images are being displayed.

To create the illusion of depth, objects may be shown at slightly different positions in each of the images along the horizontal axis. The difference between the locations of the objects in the two images is referred to as disparity. In general, to make an object appear closer to the viewer, relative to the screen, a negative disparity value may be used, whereas to make an object appear further from the user relative to the screen, a positive disparity value may be used. Pixels with positive or negative disparity may, in some examples, be displayed with more or less resolution to increase or decrease sharpness or blurriness to further create the effect of positive or negative depth from a focal point.

View synthesis can be regarded as a sampling problem which uses densely sampled views to generate a view in an arbitrary view angle. However, in practical applications, the storage or transmission bandwidth required by the densely sampled views may be relatively large. Hence, research has been performed with respect to view synthesis based on sparsely sampled views and their depth maps. Although differentiated in details, algorithms based on sparsely sampled views are mostly based on 3D warping. In 3D warping, given the depth and the camera model, a pixel of a reference view may be first back-projected from the 2D camera coordinate to a point P in the world coordinates. The point P may then be projected to the destination view (the virtual view to be generated). The two pixels corresponding to different projections of the same object in world coordinates may have the same color intensities.

Real view synthesizing unit 244 may be configured to calculate disparity values for objects (e.g., pixels, blocks, groups of pixels, or groups of blocks) of an image based on depth values for the objects or may receive disparity values encoded in the bit stream with encoded image data 254. Real view synthesizing unit 244 may use the disparity values to produce a second view 256 from the first view 250 that creates a three-dimensional effect when a viewer views first view 250 with one eye and second view 256 with the other eye. Real view synthesizing unit 244 may pass first view 250 and second view 256 to MSSU 245 to be included in a mixed reality scene that is to be displayed on image display 242.

Image display 242 may comprise a stereoscopic display or an autostereoscopic display. In general, stereoscopic displays simulate three-dimensions by displaying two images. A viewer may wear a head mounted unit, such as goggles or glasses, in order to direct one image into one eye and a second image into the other eye. In some examples, each image is displayed simultaneously, e.g., with the use of polarized glasses or color-filtering glasses. In some examples, the images are alternated rapidly, and the glasses or goggles rapidly alternate shuttering, in synchronization with the display, to cause the correct image to be shown to only the corresponding eye. Auto-stereoscopic displays do not use glasses but instead may direct the correct images into the viewer's corresponding eyes. For example, auto-stereoscopic displays may be equipped with cameras to determine where the eyes of a viewer are located and mechanical and/or electronic means for directing the images to the eyes of the viewer. Color filtering techniques, polarization filtering techniques, or other techniques may also be used to separate and/or direct images to the different eyes of a user.

Real view synthesizing unit 244 may be configured with depth values for behind the screen, at the screen, and in front of the screen, relative to a viewer. Real view synthesizing unit 244 may be configured with functions that map the depth of objects represented in encoded image data 254 to disparity values. Accordingly, real view synthesizing unit 244 may execute one of the functions to calculate disparity values for the objects. After calculating disparity values for objects of first view 250 based on 3D processing information 252, real view synthesizing unit 244 may produce second view 256 from first view 250 and the disparity values.

Real view synthesizing unit 244 may be configured with maximum disparity values for displaying objects at maximum depths in front of or behind the screen. In this manner, real view synthesizing unit 244 may be configured with disparity ranges between zero and maximum positive and negative disparity values. The viewer may adjust the configurations to modify the maximum depths in front of or behind the screen that objects are displayed by destination device 240. For example, destination device 240 may be in communication with a remote control or other control unit that the viewer may manipulate. The remote control may comprise a user interface that allows the viewer to control the maximum depth in front of the screen and the maximum depth behind the screen at which to display objects. In this manner, the viewer may be capable of adjusting configuration parameters for image display 242 in order to improve the viewing experience.

By configuring maximum disparity values for objects to be displayed in front of the screen and behind the screen, view synthesizing unit 244 may be able to calculate disparity values based on 3D processing information 252 using relatively simple calculations. For example, view synthesizing unit 244 may be configured to apply functions that map depth values to disparity values. The functions may comprise linear relationships between the depth and one disparity value within the corresponding disparity range, such that pixels with a depth value in the convergence depth interval are mapped to a disparity value of zero while objects at maximum depth in front of the screen are mapped to a minimum (negative) disparity value, thus shown as in front of the screen, and objects at maximum depth, thus shown as behind the screen, are mapped to maximum (positive) disparity values for behind the screen.

In one example for real-world coordinates, a depth range can be, e.g., [200, 1000] and the convergence depth distance can be, e.g., around 400. Then the maximum depth in front of the screen corresponds to 200 and the maximum depth behind the screen is 1000 and the convergence depth interval can be, e.g., [395, 405]. However, depth values in the real-world coordinate system may not be available or may be quantized to a smaller dynamic range, which may be, for example, an eight-bit value (ranging from 0 to 255). In some examples, such quantized depth values with a value from 0 to 255 may be used in scenarios when the depth map is to be stored or transmitted or when the depth map is estimated. A typical depth-image based rendering (DIBR) process may include converting low dynamic range quantized depth map to a map in the real-world depth map, before the disparity is calculated. Note that, conventionally, a smaller quantized depth value corresponds to a larger depth value in the real-world coordinates. In the techniques of this disclosure, however, it may be unnecessary to perform this conversion, and thus, it may be unnecessary to know the depth range in the real-world coordination or the conversion function from a quantized depth value to the depth value in the real-world coordination. Considering an example disparity range of [−disₙ, disₚ,], when the quantized depth range includes values from dₘᵢₙ (which may be 0) to dₘₐₓ (which may be 255), a depth value dₘᵢₙ is mapped to dis_{c}, and a depth value of dₘₐₓ (which may be 255) is mapped to −disₙ. Note that disₙ is positive in this example. If it is assumed that the convergence depth map interval is [d₀−δ, d₀+δ], then a depth value in this interval is mapped to a disparity of 0. In general, in this disclosure, the phrase “depth value” refers to the value in the lower dynamic range of [dₘᵢₙ, dₘₐₓ]. The δ value may be referred to as a tolerance value, and need not be the same in each direction. That is, d₀ may be modified by a first tolerance value δ₁ and a second, potentially different, tolerance value δ₂, such that [d₀−δ₂, d₀+δ₁] may represent a range of depth values that may all be mapped to a disparity value of zero. In this manner, destination device 240 may calculate disparity values without using more complicated procedures that take account of additional values such as, for example, focal length, assumed camera parameters, and real-world depth range values.

System 210 is merely one example configuration consistent with this disclosure. As discussed above, the techniques of the present disclosure may be performed by source device 220 or destination device 240. In some alternate configurations, for example, some of the functionality of MSSU 245 may be at source device 220 instead of destination device 240. In such a configuration, virtual image source 223 may implement techniques of this disclosure to generate virtual image data 223 that corresponds to an actual virtual 3D image. In other configurations, virtual image source 223 may generate data describing a 3D image so that MSSU 245 of destination device 240 can render the virtual 3D image. Additionally, in other configurations, source device 220 may transmit real images 250 and 256 directly to destination device 240 rather than transmitting one image and a disparity map. In yet other configurations, source device 220 may generate the mixed reality scene and transmit the mixed reality scene to destination device.

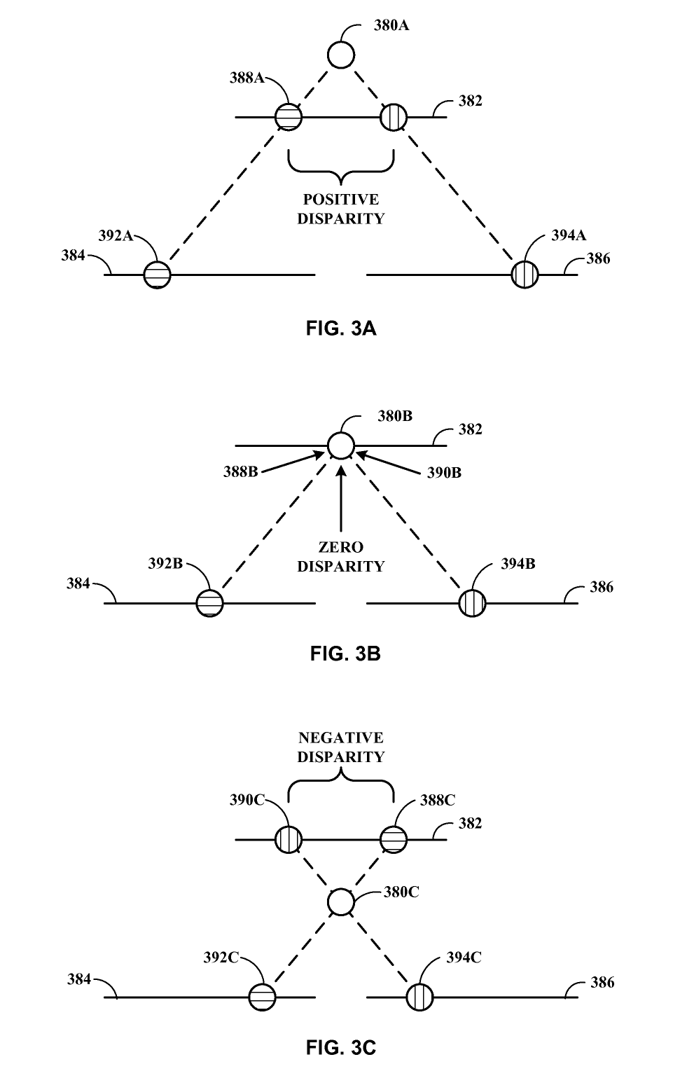

FIGS. 3A-3C are conceptual diagrams illustrating examples of positive, zero, and negative disparity values based on depths of pixels. In general, to create a three-dimensional effect, two images are shown, e.g., on a screen. Pixels of objects that are to be displayed either in front of or behind the screen have positive or negative disparity values, respectively, while objects to be displayed at the depth of the screen have disparity values of zero. In some examples, e.g., when a user wears head-mounted goggles, the depth of the “screen” may correspond to a common depth d₀.

FIGS. 3A-3C illustrate examples in which screen 382 displays left image 384 and right image 386, either simultaneously or in rapid succession. FIG. 3A depicts pixel 380A as occurring behind (or inside) screen 382. In the example of FIG. 3A, screen 382 displays left image pixel 388A and right image pixel 390A, where left image pixel 388A and right image pixel 390A generally correspond to the same object and thus may have similar or identical pixel values. In some examples, luminance and chrominance values for left image pixel 388A and right image pixel 390A may differ slightly to further enhance the three-dimensional viewing experience, e.g., to account for slight variations in illumination or color differences that may occur when viewing an object from slightly different angles.

The position of left image pixel 388A occurs to the left of right image pixel 90A when displayed by screen 382, in this example. That is, there is positive disparity between left image pixel 388A and right image pixel 390A. Assuming the disparity value is d, and that left image pixel 392A occurs at horizontal position x in left image 384, where left image pixel 392A corresponds to left image pixel 388A, right image pixel 394A occurs in right image 386 at horizontal position x+d, where right image pixel 394A corresponds to right image pixel 390A. This positive disparity may cause a viewer's eyes to converge at a point relatively behind screen 382 when the left eye of the user focuses on left image pixel 88A and the right eye of the user focuses on right image pixel 390A, creating the illusion that pixel 80A appears behind screen 382.

Left image 384 may correspond to first image 250 as illustrated in FIG. 2. In other examples, right image 386 may correspond to first image 250. In order to calculate the positive disparity value in the example of FIG. 3A, real view synthesizing unit 244 may receive left image 384 and a depth value for left image pixel 392A that indicates a depth position of left image pixel 392A behind screen 382. Real view synthesizing unit 244 may copy left image 384 to form right image 386 and change the value of right image pixel 394A to match or resemble the value of left image pixel 392A. That is, right image pixel 394A may have the same or similar luminance and/or chrominance values as left image pixel 392A. Thus screen 382, which may correspond to image display 242, may display left image pixel 388A and right image pixel 390A at substantially the same time, or in rapid succession, to create the effect that pixel 380A occurs behind screen 382.

FIG. 3B illustrates an example in which pixel 380B is depicted at the depth of screen 382. In the example of FIG. 3B, screen 382 displays left image pixel 388B and right image pixel 390B in the same position. That is, there is zero disparity between left image pixel 388B and right image pixel 390B, in this example. Assuming left image pixel 392B (which corresponds to left image pixel 388B as displayed by screen 382) in left image 384 occurs at horizontal position x, right image pixel 394B (which corresponds to right image pixel 390B as displayed by screen 382) also occurs at horizontal position x in right image 386.

Real view synthesizing unit 244 may determine that the depth value for left image pixel 392B is at a depth d₀ equivalent to the depth of screen 382 or within a small distanced from the depth of screen 382. Accordingly, real view synthesizing unit 244 may assign left image pixel 392B a disparity value of zero. When constructing right image 386 from left image 384 and the disparity values, real view synthesizing unit 244 may leave the value of right image pixel 394B the same as left image pixel 392B.

FIG. 3C depicts pixel 380C in front of screen 382. In the example of FIG. 3C, screen 382 displays left image pixel 388C to the right of right image pixel 390C. That is, there is a negative disparity between left image pixel 388C and right image pixel 390C, in this example. Accordingly, a user's eyes may converge at a position in front of screen 382, which may create the illusion that pixel 380C appears in front of screen 382.

Real view synthesizing unit 244 may determine that the depth value for left image pixel 392C is at a depth that is in front of screen 382. Therefore, real view synthesizing unit 244 may execute a function that maps the depth of left image pixel 392C to a negative disparity value −d. Real view synthesizing unit 244 may then construct right image 386 based on left image 384 and the negative disparity value. For example, when constructing right image 386, assuming left image pixel 392C has a horizontal position of x, real view synthesizing unit 244 may change the value of the pixel at horizontal position x−d (that is, right image pixel 394C) in right image 386 to the value of left image pixel 392C.

Real view synthesizing unit 244 transmits first view 250 and second view 256 to MSSU 245. MSSU 245 combines first view 250 and second view 256 to create a real 3D image. MSSU 245 also adds virtual 3D objects to the real 3D image based on virtual image data 253 to generate a mixed reality 3D image for display by image display 242. According to techniques of this disclosure, MSSU 245 renders the virtual 3D object based on a set of parameters extracted from the real 3D image.

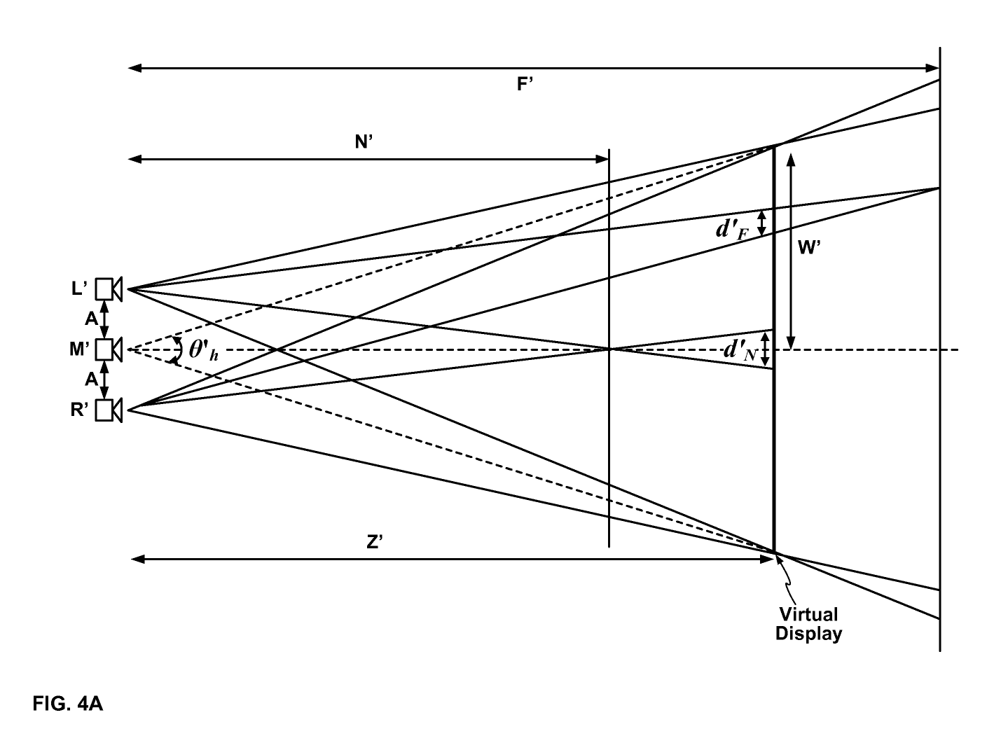

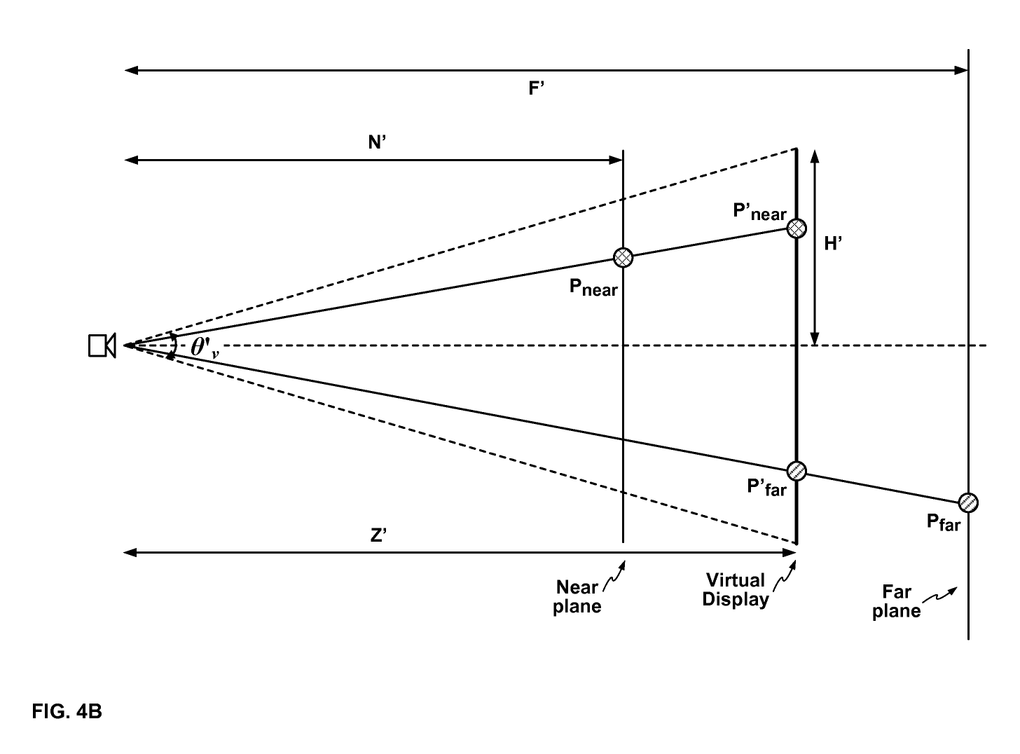

FIG. 4A shows a top-down view of a diagram of a two camera system for acquiring a stereoscopic view of a real scene and the field of view encompassed by the resulting 3D image, and FIG. 4B shows a side view of the same two camera system as shown in FIG. 4A. The two camera system may for example correspond to real image source 122 in FIG. 1 or real image source 222 in FIG. 2. L′ represents a left camera position for the two camera system, and R′ represents a right camera position for the two camera system. Cameras located at L′ and R′ can acquire the first view and second views discussed above. M′ represents a monoscopic camera position, and A represents the distance between M′ and L′ and between M′ and R′. Hence, the distance between L′ and R′ is 2*A.

Z′ represents the distance to the zero-disparity plane (ZDP). Points at the ZDP will appear to be on the display plane when rendered on a display. Points behind the ZDP will appear to be behind the display plane when rendered on a display, and points in front of the ZDP will appear to be in front of the display plane when rendered on a display. The distance from M′ to the ZDP can be measured by the camera using a laser rangefinder, infrared range finder, or other such distance measuring tool. In some operating environments, the value of Z′ may be a known value that does not need to be measured.

In photography, the term angle of view (AOV) is generally used to describe the angular extent of a given scene that is imaged by a camera. AVO is often used interchangeably with the more general term field of view (FOV). The horizontal angle of view (θ′ₕ) for a camera is a known value based on the setup for a particular camera. Based on the known value for θ′ₕ and the determined value for Z′, a value for W′, which represents half the width of the ZDP captured by the camera setup, can be calculated as follows:

$${θ}_{h}^{′} = 2 arctan \frac{{W}^{′}}{{Z}^{′}} \qquad ( 1 )$$

Using a given aspect ratio, which is a known parameter for a camera, a value of H′, which represents half of the height of the ZDP captured by the camera can be determined as followed:

$${R}^{′} = \frac{{W}^{′}}{{H}^{′}} \qquad ( 2 )$$

Thus, the camera setup's vertical angle of view (θ′ᵥ) can be calculated as follows:

$${θ}_{v}^{′} = 2 arctan \frac{{W}^{′}}{{Z}^{′} {R}^{′}} \qquad ( 3 )$$

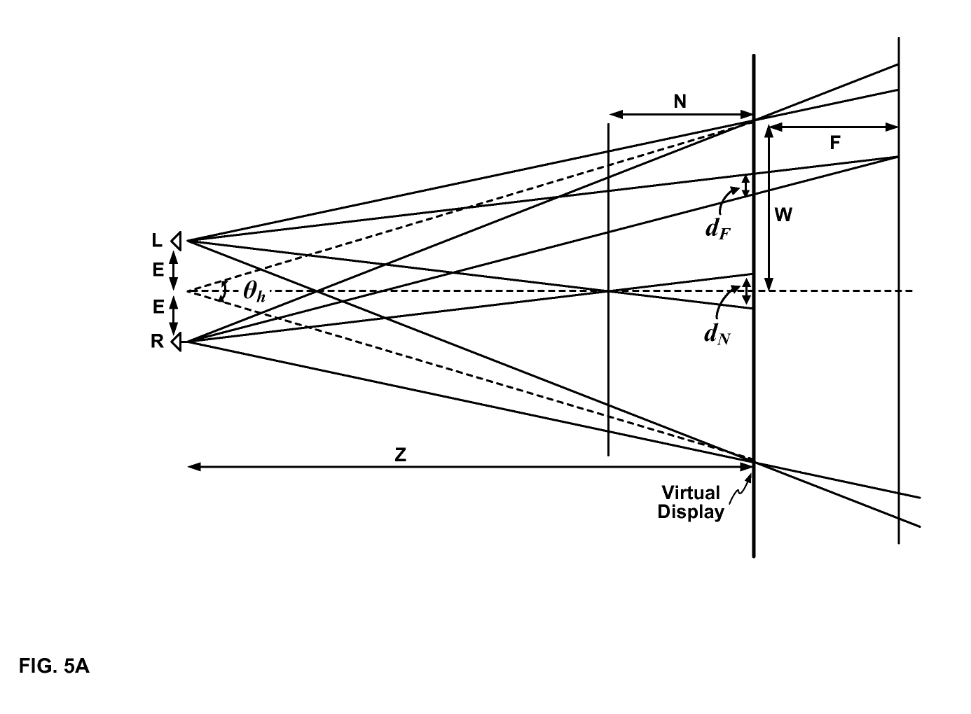

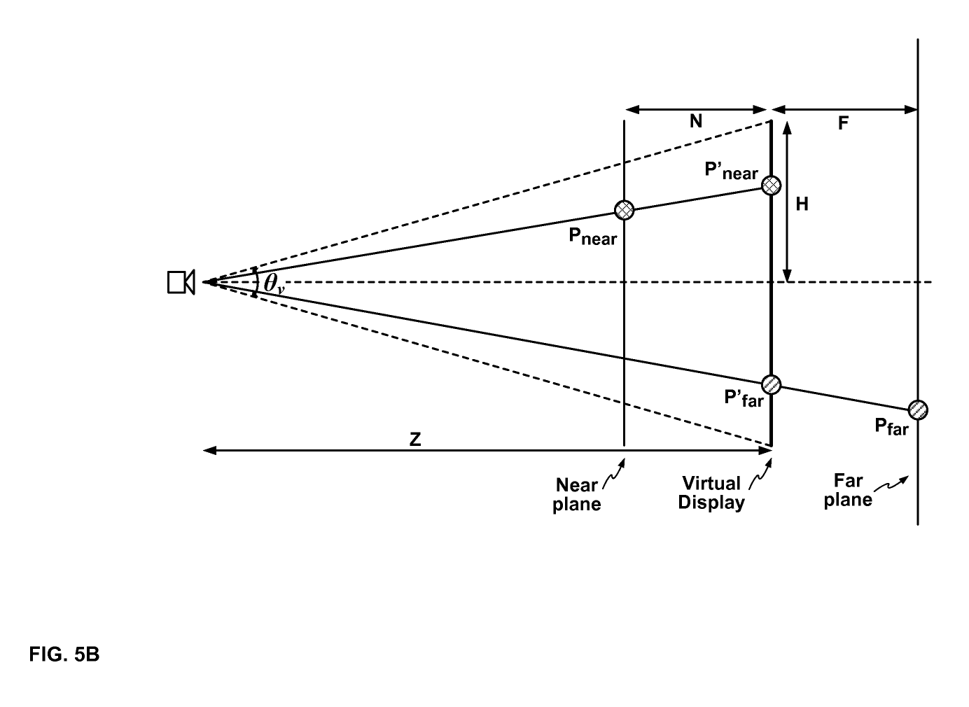

FIG. 5A shows a top-down conceptual view of a virtual display scene, and FIG. 5B shows a side view of the same virtual display scene. The parameters describing the display scene in FIGS. 5A and 5B are selected based on the parameters determined for the real scene of FIGS. 4A and 4B. In particular, the horizontal AOV for the virtual scene (θₕ) is selected to match the horizontal AOV for the real scene (θ′ₕ), the vertical AOV for the virtual scene (θᵥ) is selected to match the vertical AOV for the real scene (θ′ᵥ), and the aspect ratio (R) of the virtual scene is selected to match the aspect ratio of the real scene (R′). The field of view of the virtual display scene is chosen to match that of the real 3D image acquired by the camera so that the virtual scene has the same viewing volume as the real scene and that there are no visual distortions when the virtual objects are rendered.

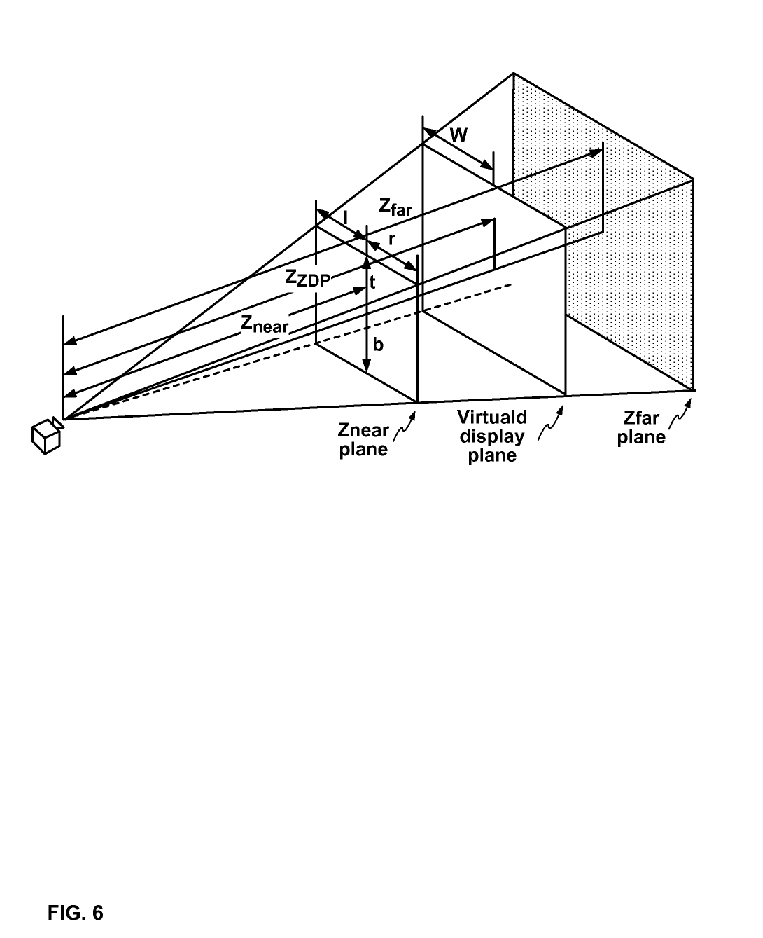

FIG. 6 is a 3D illustration showing a 3D viewing frustum for rendering a mixed-reality scene. The 3D viewing frustum can be defined by an application program interface (API) for generating 3D graphics. Open Graphics Library (OpenGL), for example, is one common cross-platform API used for generating 3D computer graphics. A 3D viewing frustum in OpenGL can be defined by six parameters (a left boundary (l), right boundary (r), top boundary (t), bottom boundary (b), Zₙₑₐᵣ, and Z_{far}), shown in FIG. 6. The l, r, t, and b parameters can be determined using the horizontal and vertical AOVs determined above, as follows:

$$\begin{matrix}l = {Z}_{near} tan ( \frac{{θ}_{h}}{2} ) & ( 4 ) \\ t = {Z}_{near} tan ( \frac{{θ}_{v}}{2} ) & ( 5 )\end{matrix}$$

In order to determine values for l and t, a value for Zₙₑₐᵣ needs to be determined. Zₙₑₐᵣ and Z_{far} are selected to meet the following constraint:

Zₙₑₐᵣ<Z_{ZDP}<Z_{far} (6)

Using the values of W and θₕ determined above, a value of Z_{ZDP} can be determined as follows:

$${Z}_{ZDP} = \frac{W}{tan \frac{{θ}_{h}}{2}} \qquad ( 7 )$$

After determining a value for Z_{ZDP}, values for Zₙₑₐᵣ and Z_{far} are chosen based on the real scene near and far clipping plane corresponding to the virtual display plane. If ZDP is on the display for instance, then ZDP is equal to the distance from the viewer to the display. Although the ratio between Z_{far} and Zₙₑₐᵣ may affect the depth buffer precision due to depth buffer nonlinearity issues, the depth buffer usually has higher precision in areas closer to the near plane and lower precision in areas closer to far plane. This variation in precision may improve the image quality of objects closer to a viewer. Thus, values of Zₙₑₐᵣ and Z_{far} might be selected as follows:

$$\begin{matrix}{Z}_{near} = {C}_{Zn} cot ( \frac{{θ}_{h}}{2} ) and {Z}_{far} = {C}_{Zf} cot ( \frac{{θ}_{h}}{2} ) & ( 8 ) \\ {C}_{Zn} = 0.6 and {C}_{Zf} = 3.0 & ( 9 )\end{matrix}$$

Other values of C_{Zn}, and C_{Zf} may also be selected based on the preferences of system designers and system users. After determining values for Zₙₑₐᵣ and Z_{far}, values for l and I can be determined using equations (4) and (5) above. Values for r and b can be the negatives of l and t, respectively. OpenGL frustum parameters are derived. Thus, an OpenGL projection matrix can be derived as follows:

$$[ \begin{matrix}cot ( \frac{{θ}_{h}}{2} ) & 0 & 0 & 0 \\ 0 & cot ( \frac{{θ}_{v}}{2} ) & 0 & 0 \\ 0 & 0 & - \frac{{Z}_{near} + {Z}_{far}}{{Z}_{far} - {Z}_{near}} & \frac{- 2 {Z}_{near} {Z}_{far}}{{Z}_{far} - {Z}_{near}} \\ 0 & 0 & - 1 & 0\end{matrix} ]$$

Using the projection matrix above, a mixed reality scene can be rendered where the projective scale of virtual objects in the scene matches the projective scale of real objects in the scene. Based on equations 4 and 5 above, it can be seen that:

$$\begin{matrix}cot ( \frac{{θ}_{h}}{2} ) = \frac{{z}_{near}}{l} , and & ( 10 ) \\ cot ( \frac{{θ}_{v}}{2} ) = \frac{{z}_{near}}{t} & ( 11 )\end{matrix}$$

In addition to projective scale match, aspects of this disclosure further include matching the disparity scale between the real 3D image and a virtual 3D image. Referring back to FIG. 4, the disparity of the real image can be determined as follows:

$${d}_{N}^{′} = \frac{2 A ( {Z}^{′} - {N}^{′} )}{{N}^{′}} and {d}_{F}^{′} = \frac{2 A ( {F}^{′} - {Z}^{′} )}{{F}^{′}} \qquad ( 12 )$$

As discussed previously, the value of A is known based on the 3D camera used, and the value of Z′ can be either known or measured. The values of N′ and F′ are equal to the values of Zₙₑₐᵣ and Z_{far} respectively, determined above. To match the disparity scale of the virtual 3D image to the real 3D image, the near plane disparity of the virtual image (d_{N}) is set equal to d′_{N}, and the far plane disparity of the virtual image (d_{F}) is set equal to d′_{F}. For determining an eye separation value (E) for the virtual image, either of the following equations can be solved:

$${d}_{N} = \frac{2 EN}{Z - N} and {d}_{F} = \frac{2 EF}{Z + F} \qquad ( 13 )$$

Using the near plane disparity (d_{N}) as an example

N′=kZ′ and N=(1−k)Z (14)

Thus, equation 13, for the near disparity plane, turns into:

$${d}_{N}^{′} = \frac{2 A ( 1 - k )}{k} \qquad ( 15 )$$

Next, the real world coordinates need to be mapped into image plane pixel coordinates. Assuming the camera resolution of the 3D camera is known to be W′ₚ×H′ₚ, then the near plane disparity becomes:

$${d}_{N p}^{′} = \frac{2 A ( 1 - k )}{k {W}^{′}} {W}_{p}^{′} \qquad ( 16 )$$

Mapping viewer space disparity from graphics coordinates into display pixel coordinates, the display resolution is Wₚ×Hₚ, where:

$${d}_{N p} = \frac{2 E ( 1 - k )}{k W} {W}_{p} \qquad ( 17 )$$

Using equality of disparity, where d′_{Np}=d_{Np} and following scaling ratio (S) from display to captured image:

$$S = \frac{{W}_{p}}{{W}_{p}^{′}} \qquad ( 18 )$$

The eye separation value, which can be used to determine a viewer location in OpenGL, can be determined as follows:

$$E = \frac{AW}{{SW}^{′}} \qquad ( 19 )$$

The eye separation value is a parameter used in an OpenGL function calls for generating virtual 3D images.

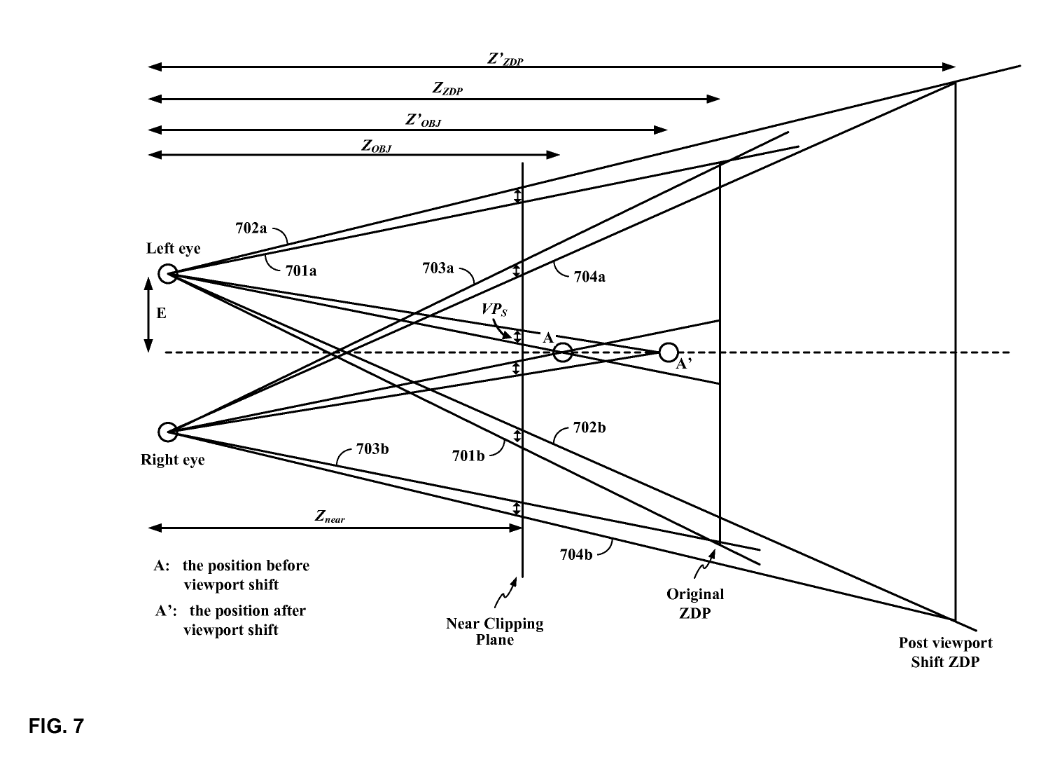

FIG. 7 shows a top-down view of a viewing frustum such as the viewing frustum of FIG. 6. In OpenGL, all points within the viewing frustum are typically projected onto the near clipping plane (shown in FIG. 7, for example.), then mapped to viewport screen coordinates. By moving both the left viewport and right viewport, the disparity of certain parts of a scene can be altered. Thus, both ZDP adjustment and view depth adjustment can be achieved. In order to keep the undistorted stereo view, both the left viewport and the right viewport can be shifted a same amount of distance symmetrically in opposing directions. FIG. 7 shows the view space geometry when the left viewport is shifted left a small amount of distance and the right viewport is shifted right by the same amount of distance. Lines 701a and 701b represent the original left viewport configuration, and lines 702a and 702b lines represent the changed left viewport configuration. Lines 703a and 703b represent the original right viewport configuration, and lines 704a and 704b represent the changed right viewport configuration. Z_{obj} represents an object distance before shifting of the viewports, and Z′_{obj} represents an object distance after the shirting of the viewports. Z_{ZDP} represents the zero disparity plane distance before shifting of the viewports, and Z′_{ZDP} represents the zero disparity plane distance after shifting of the viewports. Zₙₑₐᵣ represents the near clipping plane distance, and E represents the eye separation value determined above. Point A is the object depth position before the shifting of the viewports, and point A′ is the object depth position after shifting of the viewports.

The mathematical relationship of the depth change of shifting the viewports is derived as follows, with Δ is half of the projection viewport size of the object, VPₛ is an amount the viewports are shifted. Based on the trigonometry of points A, A′, and the positions of a left eye and right eye, equations (20) and (21) can be derived:

$$\begin{matrix}Δ = E * \frac{{Z}_{obj} - {Z}_{near}}{{Z}_{obj}} & ( 20 ) \\ {VP}_{s} + Δ = E * \frac{{Z}_{obj}^{′} - {Z}_{near}}{{Z}_{obj}^{′}} & ( 21 )\end{matrix}$$

Equations (20) and (21) can be combined to derive the object distance in viewer space after shifting of the viewport, as follows:

$${Z}_{obj}^{′} = \frac{{Z}_{near} * {Z}_{obj} * E}{{Z}_{near} * E - {Z}_{obj} * {VP}_{s}} \qquad ( 22 )$$

Based on equation (22), a new ZDP position in viewer space can be derived as follows:

$${Z}_{ZDP}^{′} = \frac{{Z}_{near} * {Z}_{ZDP} * E}{{Z}_{near} * E - {Z}_{ZDP} * {VP}_{s}} \qquad ( 23 )$$

Using Z′_{ZDP}, a new projection matrix can be generated using new values for Zₙₑₐᵣ and Z_{far}.

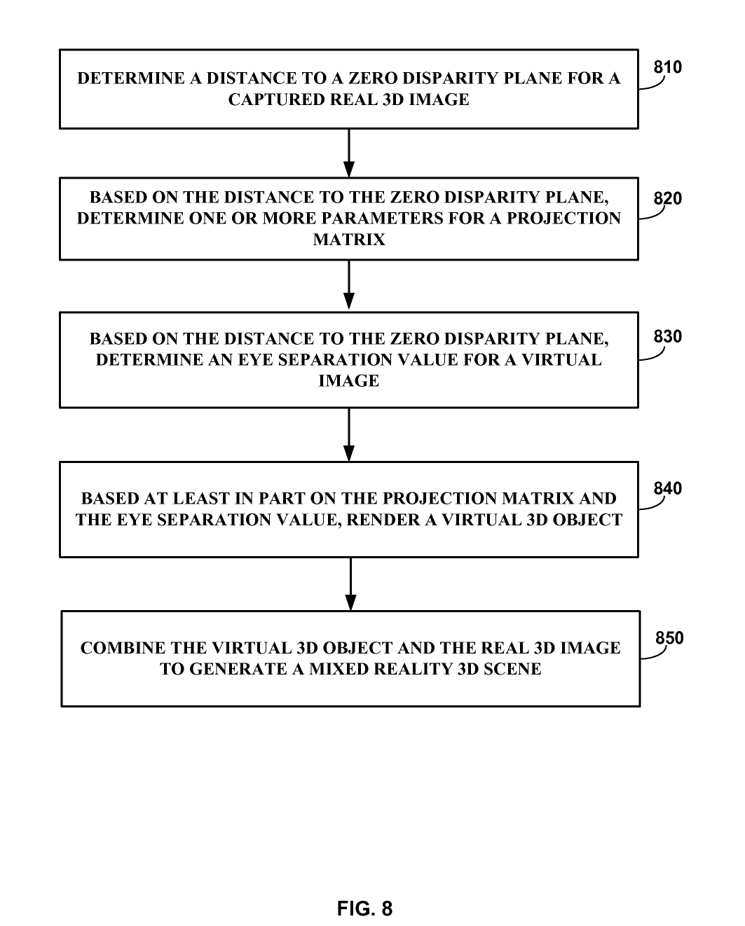

FIG. 8 is a flow diagram illustrating techniques of this disclosure. The techniques will be described with references to system 210 of FIG. 2, but the techniques are not limited to such a system. For a captured real 3D image, real image source 222 can determine a distance to a zero disparity plane (810). Based on the distance to the zero disparity plane, MSSU 245 can determine one or more parameters for a projection matrix (820). Based on the distance to the zero disparity plane, MSSU 245 can also determine an eye separation value for a virtual image (830). Based at least in part on the projection matrix and the eye separation value, a virtual 3D object can be rendered (840). As discussed above, the determination of the projection matrix and the rendering of the virtual 3D object may be performed by a source device, such as source device 220, or by a destination device, such as destination device 240. MSSU 245 can combine the virtual 3D object and the real 3D image to generate a mixed reality 3D scene (850). The generating of the mixed reality scene may similarly be performed either by a source device or a destination device.

The techniques of this disclosure may be embodied in a wide variety of devices or apparatuses, including a wireless handset, and integrated circuit (IC) or a set of ICs (i.e., a chip set). Any components, modules or units have been described provided to emphasize functional aspects and does not necessarily require realization by different hardware units, etc.

Accordingly, the techniques described herein may be implemented in hardware, software, firmware, or any combination thereof. Any features described as modules or components may be implemented together in an integrated logic device or separately as discrete but interoperable logic devices. If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates code in the form of instructions or data structures and that can be accessed, read, and/or executed by a computer.

The code may be executed by one or more processors, such as one or more digital signal processors (DSPs), general purpose microprocessors, an application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated software modules or hardware modules configured for encoding and decoding, or incorporated in a combined video encoder-decoder (CODEC). Also, the techniques could be fully implemented in one or more circuits or logic elements.

Various aspects of the disclosure have been described. These and other aspects are within the scope of the following claims.

Many aspects of the disclosure have been described. Various modifications may be made without departing from the scope of the claims. These and other aspects are within the scope of the following claims.

1. A method comprising:
determining a distance to a zero disparity plane for a real three-dimensional (3D) image;
determining one or more parameters for a projection matrix based at least in part on the distance to the zero disparity plane;
rendering a virtual 3D object based at least in part on the projection matrix;
combining the real image and the virtual object to generate a mixed reality 3D image.

2. The method of claim 1, further comprising:
determining an eye separation value based at least in part on the distance to the zero disparity plane;
rendering the virtual 3D object based at least in part on the eye separation value.

3. The method of claim 1, wherein the real 3D image is captured by a stereo camera.

4. The method of claim 3, wherein the method further comprises:
determining an aspect ratio of the stereo camera; and,
using the aspect ratio to determine at least one of the one or more parameters for the projection matrix.

5. The method of claim 1, wherein the parameters comprise a left boundary parameter, a right boundary parameter, a top boundary parameter, a bottom boundary parameter, a near clipping plane parameter, and a far clipping plane parameter.

6. The method of claim 1, further comprising:
determining a near plane disparity value for the real 3D image;
rendering the virtual 3D object with the near plane disparity value.

7. The method of claim 1, further comprising:
determining a far plane disparity value for the real 3D image:
rendering the virtual 3D object with the far plane disparity value.

8. The method of claim 1, further comprising:
shifting a viewport of the mixed-reality 3D image.

9. A system for processing three-dimensional (3D) video data, the system comprising:
a real 3D image source, wherein the real 3D image source is configured to determine a distance to a zero disparity plane for a captured 3D image;
a virtual image source configured to:
determine one or more parameters for a projection matrix based at least on the distance to the zero disparity plane;
render a virtual 3D object based at least in part on the projection matrix;
a mixed scene synthesizing unit configured to combining the real image and the virtual object to generate a mixed reality 3D image.

10. The system of claim 9, wherein the virtual image source is further configured to,
determine an eye separation value based at least on the distance to the zero disparity plane and render the virtual 3D object based at least in part on the eye separation value.

11. The system of claim 9, wherein the real 3D image source is a stereo camera.

12. The system of claim 11, wherein the virtual image source is further configured to determine an aspect ratio of the stereo camera and use the aspect ratio to determine at least one of the one or more parameters for the projection matrix.

13. The system of claim 9, wherein the parameters comprise a left boundary parameter, a right boundary parameter, a top boundary parameter, a bottom boundary parameter, a near clipping plane parameter, and a far clipping plane parameter.

14. The system of claim 9, wherein the virtual image source is further configured to determine a near plane disparity value for the real 3D image and render the virtual 3D object with the same near plane disparity value.

15. The system of claim 9, wherein the virtual image source is further configured to determine a far plane disparity value for the real 3D image and render the virtual 3D object with the same far plane disparity value.

16. The system of claim 9, wherein the mixed scene synthesizing unit is further configured to shift a viewport of the mixed-reality 3d image.

17. An apparatus comprising:
means for determining a distance to a zero disparity plane for a real three-dimensional (3D) image;
means for determining one or more parameters for a projection matrix based at least in part on the distance to the zero disparity plane;
means for rendering a virtual 3D object based at least in part on the projection matrix;
means for combining the real image and the virtual object to generate a mixed reality 3D image.

18. The apparatus of claim 17, further comprising:
means for determining an eye separation value based at least in part on the distance to the zero disparity plane;
means for rendering the virtual 3D object based at least in part on the eye separation value.

19. The apparatus of claim 17, wherein the real 3D image is captured by a stereo camera.

20. The apparatus of claim 19, wherein the apparatus further comprises:
means for determining an aspect ratio of the stereo camera; and,
means for using the aspect ratio to determine at least one of the one or more parameters for the projection matrix.

21. The apparatus of claim 17, wherein the parameters comprise a left boundary parameter, a right boundary parameter, a top boundary parameter, a bottom boundary parameter, a near clipping plane parameter, and a far clipping plane parameter.

22. The apparatus of claim 17, further comprising:
means for determining a near plane disparity value for the real 3D image;
means for rendering the virtual 3D object with the near plane disparity value.

23. The apparatus of claim 17, further comprising:
means for determining a far plane disparity value for the real 3D image;
means for rendering the virtual 3D object with the far plane disparity value.

24. The apparatus of claim 17, further comprising:
means for shifting a viewport of the mixed-reality 3D image.

25. A non-transitory, computer readable storage medium tangibly storing one or more instructions, which when executed by one or more processors cause the one or more processors to:
determine a distance to a zero disparity plane for a real three-dimensional (3D) image;
determine one or more parameters for a projection matrix based at least in part on the distance to the zero disparity plane;
render a virtual 3D object based at least in part on the projection matrix;
combine the real image and the virtual object to generate a mixed reality 3D image.

26. The computer-readable storage medium of claim 25, storing further instructions, which when executed by the one or more processors cause the one or more processors to:
determine an eye separation value based at least in part on the distance to the zero disparity plane;
render the virtual 3D object based at least in part on the eye separation value.

27. The computer-readable storage medium of claim 25, wherein the real 3D image is captured by a stereo camera.

28. The computer-readable storage medium of claim 27, storing further instructions, which when executed by the one or more processors cause the one or more processors to:
determine an aspect ratio of the stereo camera; and,
use the aspect ratio to determine at least one of the one or more parameters for the projection matrix.

29. The computer-readable storage medium of claim 27, wherein the parameters comprise a left boundary parameter, a right boundary parameter, a top boundary parameter, a bottom boundary parameter, a near clipping plane parameter, and a far clipping plane parameter.

30. The computer-readable storage medium of claim 25, storing further instructions, which when executed by the one or more processors cause the one or more processors to:
determine a near plane disparity value for the real 3D image;
render the virtual 3D object with the near plane disparity value.

31. The computer-readable storage medium of claim 25, storing further instructions, which when executed by the one or more processors cause the one or more processors to:
determine a far plane disparity value for the real 3D image;
render the virtual 3D object with the far plane disparity value.

32. The computer-readable storage medium of claim 25, storing further instructions, which when executed by the one or more processors cause the one or more processors to:
shift a viewport of the mixed-reality 3D image.
